(19) United States
(12) Patent Application Publication
(10) Pub. No.: US 2022/0142178 A1
(43) Pub. Date: May 12, 2022

(54) METHODS OF ENHANCING CROP QUALITY WITH MICROALGAE COMPOSITIONS

(71) Applicants: Edgard Jauregui, (US); Lindsay Vicars, (US); Karl Wyant, (US); HELIAE DEVELOPMENT, LLC, Gilbert, AZ (US)

(72) Inventors: Edgard Jauregui, Casa Grande, AZ (US); Lindsay Vicars, Mesa, AZ (US); Karl Wyant, Tempe, AZ (US)

(21) Appl. No.: 17/524,539

(22) Filed: Nov. 11, 2021

Related U.S. Application Data
(60) Provisional application No. 63/112,550, filed on Nov. 11, 2020.
(60) Provisional application No. 63/230,024, filed on Aug. 5, 2021.
(60) Provisional application No. 63/272,375, filed on Oct. 27, 2021.

(51) Int. Cl. A01N 65/03; C12N 1/02; C12N 1/12

(52) U.S. Cl. CPC A01N 65/03; C12R 2001/89; C12N 1/125; C12N 1/02

(57) ABSTRACT

The present invention provides a method for improving crop yield and/or the quality of a harvested crop comprising the step of applying a composition comprising a culture of microalgae to a plant, a plant propagation material, or a locus where said plant or plant propagation material is intended to be grown.

### CROSS REFERENCE TO RELATED APPLICATIONS

This application claims the benefit of U.S. Provisional Patent Application No. 63/112,550, filed Nov. 11, 2020; U.S. Provisional Patent Application No. 63/230,024, filed Aug. 5, 2021; and U.S. Provisional Patent Application No. 63/272,375, filed Oct. 27, 2021, each application entitled METHODS OF ENHANCING CROP QUALITY WITH MICROALGAE COMPOSITIONS. The entire contents of each of the foregoing applications are incorporated by reference herein.

### TECHNICAL FIELD

The present invention relates to methods of improving crop yield and/or the quality of a harvested crop via application of a composition comprising a culture of microalgae (e.g., Chlorella).

### BACKGROUND

It is a common practice in the agricultural field both for food production, ornamental shrubs and trees, and lawn grasses to accelerate growth by the application of chemical fertilizers, e.g., nitrates, phosphates, and potassium compounds, and also chemical materials such as pesticides, herbicides, and fungicides, etc., that can be toxic. Further, it is a present practice to overload the crops with these chemical materials and to repeatedly treat most crops multiple times in a growing season (typically four times, may be as many as eight times depending on the plant and location) because these water-soluble substances would wash off. The significant amount of runoff means that users must use more of these substances and apply more times, which increases both the monetary and labor cost. The runoff also results in these chemical materials finding their way into the soil and the ground water, and into rivers, lakes, ponds and ultimately the bays and oceans. While these chemicals do enhance the growth of desirable plants, the runoff has toxic effects. Thus, there is a need for environmentally friendly and sustainable means for enhancing plant growth and improving crop quality.

Chlorella, a genus of single-celled green microalgae, is considered the most photosynthetically efficient organism in the world. Chlorella's chlorophyll content can reach levels as high as 8%; approximately 16 times more than most green foods. Chlorella conducts photosynthesis through the absorption of sunlight by chlorophyll A, chlorophyll B, and carotenoid pigments located in its chloroplast.

It has now been recognized that various characteristics of plants can be enhanced through the application of effective amounts of biomass that has been obtained from the cell tissue of Chlorella species. In addition, application of Chlorella biomass to soil increases soil aggregation and water retention thereby providing a more productive growth medium for plants. There is a need to develop effective Chlorella-based agricultural products to supplement or replace chemical soil amendments and to enhance crop yield and quality in a sustainable manner.

### SUMMARY

The present invention provides a method for improving crop yield and/or the quality of a harvested crop comprising the step of applying a composition comprising a culture of microalgae to a plant, a plant propagation material, and/or a locus where said plant or plant propagation material is intended to be grown.

In certain aspects, the composition comprises a culture of Aurantiochytrium, Botryococcus, Chlorella, Chlamydomonas, Desmodesmus, Dunaliella, Scenedesmus, Pavolv, Phaeodactylum, Nannochloropsis, Spirulina, Galdieria, Haematococcus, Isochrysis, Porphyridium, Schizochytrium, Thraustochytrium, Tetraselmis, or a combination thereof. In one aspect, the composition comprises a culture of Chlorella. In another aspect, the Chlorella are whole cells, lysed cells, dried cells, cells that have been subjected to an extraction process, or a combination thereof.

In yet other aspects, the improvement in the quality of the harvested crop is an increase in individual crop weight, individual crop size, flesh color rating, crop or fruit grade, protein content, oil content, carbohydrate content, fiber content, grain hardness, number of hard and vitreous kernels of amber color (HVAC), relative feed value (RFV), total digestible nutrients (TDN), crude protein (CP), nutritional quality, forage quality, or forage digestibility compared to a corresponding crop to which the composition was not applied.

In one aspect, the improvement in crop or fruit grade is an enhancement in one or more crop or fruit grade assessments selected from the group consisting of: sugar content or soluble solids, whole crop or fruit size, starch content, crop or fruit firmness or pressure, crop or fruit acidity, crop or fruit color, seed color, crop or fruit taste, crop or fruit texture, and crop or fruit aroma.

In some aspects, the improvement in the quality of the harvested crop is a decrease in grain or rind thickness, kernel damage, grain or kernel chalkiness, or the number of nut doubles compared to a corresponding crop to which the composition was not applied.

In one aspect, the composition is applied to soil in the immediate vicinity of the plant, seedling, or plant propagation material, as a seed treatment, and/or as a foliar spray. In another aspect, the composition is applied as a soil drench or foliar spray at a rate of between about 0.5 qt/acre (1.17 L/ha) and about 4 qt/acre (9.6 L/ha). In yet another aspect, the composition is applied as a seed treatment at a rate of about 1 oz/cwt (0.58 ml/kg) to about 6 oz/cwt (3.49 ml/kg).

In certain aspects, the composition is applied to a plant or a plant propagation material of almonds, wheat, alfalfa, canola, corn, soybeans, or a citrus fruit.

In other aspects, multiple applications of the composition are made to the plant, plant propagation material, and/or locus where the plant or plant propagation material is intended to be grown.

In one aspect, the present invention provides a method for improving the yield and/or the quality of a harvested almond crop comprising the step of applying a composition comprising a culture of microalgae to an almond tree and/or a locus where an almond tree is intended to be grown, wherein improvement in quality is measured as an increase in individual nut weight and/or a decrease in the number of doubles in the harvested almond crop compared to a corresponding almond crop to which the composition was not applied.

In another aspect, the present invention provides a method for improving the yield and/or the quality of a harvested alfalfa crop comprising the step of applying a composition comprising a culture of microalgae to an alfalfa plant, alfalfa propagation material, and/or a locus where an alfalfa plant is intended to be grown, wherein improvement in quality is measured as an increase in relative feed value (RFV), total digestible nutrients (TDN), crude protein (CP), forage quality, or forage digestibility in the harvested alfalfa crop compared to a corresponding alfalfa crop to which the composition was not applied.

In another aspect, the present invention provides a method for improving the yield and/or the quality of a harvested wheat crop comprising the step of applying a composition comprising a culture of microalgae to a wheat plant, wheat propagation material, and/or a locus where a wheat plant is intended to be grown, wherein improvement in quality is measured as an increase in protein content, grain hardness, or the number of hard and vitreous kernels of amber color (HVAC) in the harvested wheat crop compared to a corresponding wheat crop to which the composition was not applied.

In another aspect, the present invention provides a method for improving the yield and/or the quality of a harvested canola crop comprising the step of applying a composition comprising a culture of microalgae to a canola plant, canola propagation material, and/or a locus where a canola plant is intended to be grown, wherein improvement in quality is measured as an increase in oil content in the harvested canola crop compared to a corresponding canola crop to which the composition was not applied.

In another aspect, the present invention provides a method for improving the yield and/or the quality of a harvested corn crop comprising the step of applying a composition comprising a culture of microalgae to a corn plant, corn propagation material, and/or a locus where a corn plant is intended to be grown, wherein improvement in quality is measured as an increase in protein content in the harvested corn crop compared to a corresponding corn crop to which the composition was not applied.

In another aspect, the present invention provides a method for improving the yield and/or the quality of a harvested soybean crop comprising the step of applying a composition comprising a culture of microalgae to a soybean plant, soybean propagation material, and/or a locus where a soybean plant is intended to be grown, wherein improvement in quality is measured as an increase in protein content in the harvested soybean crop compared to a corresponding soybean crop to which the composition was not applied.

In another aspect, the present invention relates to a method for improving the yield and/or the quality of a harvested citrus fruit crop comprising the step of applying a composition comprising a culture of microalgae to a citrus fruit tree, citrus fruit propagation material, and/or a locus where a citrus fruit tree is intended to be grown, wherein improvement in quality is measured as an increase in fruit size or flesh color rating and/or a decrease in rind thickness in the harvested citrus fruit crop compared to a corresponding citrus fruit crop to which the composition was not applied. In some aspects, the citrus fruit is an orange, lemon, lime, grapefruit, mandarin orange, tangerine, kumquat, pomelo, citron, papeda, or clementine.

In certain aspects, the present invention relates to a method for improving the yield and/or the quality of a harvested apple crop comprising the step of applying a composition comprising a culture of microalgae to an apple tree, apple propagation material, and/or a locus where an apple tree is intended to be grown, wherein improvement in quality is measured as an improvement in fruit grade in the harvested apple crop compared to a corresponding apple crop to which the composition was not applied.

In one aspect, the improvement in fruit grade is an enhancement in one or more fruit grade assessments selected from the group consisting of: sugar content or soluble solids, whole fruit size, starch content, fruit firmness or pressure, fruit acidity, fruit color, seed color, fruit taste, fruit texture, and fruit aroma.

In another aspect, the apple tree is selected from the group consisting of Idared, Braeburn, Cameo, Cortland, crabapple, Empire, Fuji, Gala, Ginger Gold, Golden Delicious, Granny Smith, Honeycrisp, Jonagold, Jonathan, Macintosh, Mutsu, Nittany, Pink Lady, Rome, Red Delicious, Stayman, Winesap and York.

### BRIEF DESCRIPTION OF THE DRAWINGS

FIG. 1 depicts the average individual nut weights (oz) of almonds harvested from untreated control (“Grower Standard”) trees and trees treated with PHYCOTERRA® (whole cell Chlorella microalgae) at 1 qt/acre, 2 qt/acre, or 3 qt/acre.

FIG. 2 depicts the relative percentage of harvested almonds presenting as doubles (i.e., lower grade almonds) harvested from untreated control (“Grower Standard”) trees and trees treated with PHYCOTERRA® (whole cell Chlorella microalgae) at 1 qt/acre, 2 qt/acre, or 3 qt/acre.

FIG. 3 depicts the meat yield (lb/acre) of almonds harvested from untreated control (“Grower Standard”) trees and trees treated with PHYCOTERRA® (whole cell Chlorella microalgae) at 1 qt/acre, 2 qt/acre, or 3 qt/acre.

FIG. 4 depicts the yield (bu/acre) of durum wheat harvested from untreated control (“Grower Standard”) plants; plants treated with PHYCOTERRA® ST (lysed Chlorella microalgae) at 5 oz/cwt; and plants treated with PHYCOTERRA® ST (lysed Chlorella microalgae) at 5 oz/cwt and PHYCOTERRA® (whole cell Chlorella microalgae) at 2 qt/acre.

FIG. 5 depicts the yield (ton/acre) of alfalfa harvested from a first cut in the month of June with control plants (hashed bar) and treated plants (solid bars) where PHYCOTERRA® (whole cell Chlorella microalgae) was applied at 0.5 qt/acre, 1 qt/acre, 1.5 qt/acre, or 2 qt/acre.

FIG. 6 depicts the yield (ton/acre) of alfalfa harvested from a second cut in the month of July with control plants (hashed bar) and treated plants (solid bars) where PHYCOTERRA® (whole cell Chlorella microalgae) was applied at 0.5 qt/acre, 1 qt/acre, 1.5 qt/acre, or 2 qt/acre.

FIG. 7 depicts the yield (bu/acre) of soybeans from untreated control (“Grower Standard”) plants and plants treated with PHYCOTERRA® FX (lysed Chlorella microalgae) at 1 qt/acre.

FIG. 8A depicts the average navel orange fruit size produced by untreated control trees (i.e., “Grower Standard) and trees treated with PHYCOTERRA® (whole cell Chlorella microalgae). FIG. 8B depicts the average navel orange rind thickness produced by untreated control trees (i.e., “Grower Standard) and trees treated with PHYCOTERRA® (whole cell Chlorella microalgae). FIG. 8C depicts the average navel orange flesh color rating produced by untreated control trees (i.e., “Grower Standard) and trees treated with PHYCOTERRA® (whole cell Chlorella microalgae).

FIG. 9A depicts the percent of apples determined to be Category 1 (i.e., US Extra Fancy) from untreated control trees (i.e., “Grower Standard) and trees treated with PHYCOTERRA® (whole cell Chlorella microalgae). FIG. 9B depicts the average apple weights from untreated control trees (i.e., “Grower Standard) and trees treated with PHYCOTERRA® (whole cell Chlorella microalgae).

### DETAILED DESCRIPTION

As used herein and in the appended claims, the singular forms “a,” “an,” and “the” include plural referents unless the context clearly dictates otherwise. For example, “a” or “an” means “at least one” or “one or more.”

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

The term “microalgae” as used herein refers to microscopic single cell organisms such as microalgae, cyanobacteria, algae, diatoms, dinoflagellates, freshwater organisms, marine organisms, or other similar single cell organisms capable of growth in phototrophic, mixotrophic, or heterotrophic culture conditions.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

The term “auxiliary” as used herein refers to an inert ingredient commonly used in agricultural compositions. Examples of auxiliaries include, but are not limited to, extenders, solvents, diluents, emulsifiers, dispersants, binders, fixing agents, wetting agents, dyes, pigments, antifoams, preservatives, secondary thickeners, and stickers.

“G lignin” refers to guaiacyl lignin. Guaiacyl lignin is composed principally of coniferyl alcohol units, while guaiacyl-syringyl lignin contains monomeric units from coniferyl and sinapyl alcohol. In general, guaiacyl lignin is found in softwoods, while guaiacyl-syringyl lignin is present in hardwoods.

“Feed value” refers to the forage quality, such as fiber content, digestibility, and available carbohydrate resources available to livestock. Enhanced feed value or alfalfa quality is determined by the Relative Feed Value (RFV) expressed as a percentage of alfalfa at 100% bloom and is used as a predictor of feed value in the field. Components that effect feed value are acid detergent lignin concentration and G lignin and neutral detergent fiber digestibility.

“Acid detergent lignin” (ADL) is an estimate of lignin content. Lignin is an indigestible component of forage fiber (NDF) that is believed to limit the extent to which forage fiber can be digested by ruminant animals.

“Neutral Detergent Fiber Digestibility” (NDFD) content of forage is a measure of the digestibility of a forage fiber and can be measured in vitro and predicted using Near Infrared Reflectance Spectroscopy (NIRS). The higher the NDFD value the more digestible the forage.

The “lower stem” of the alfalfa plant is described as the 15-cm stem sections of the stems of the alfalfa plant that have been harvested 2.5″ above ground level with the leaves completely removed. The lower stem is the most lignified part of the alfalfa plant, and the least digestible.

Alfalfa is generally harvested as alfalfa “hay” or “silage”, the differences between the two being based on percent moisture and crude protein. For alfalfa silage, digestible protein should be 60% to 70% of crude protein. Alfalfa is most often harvested as “hay” and can be stored as bales or stacks but can also be made into silage, grazed or fed as greenchop. For the purposes of this invention “whole plant” is the equivalent of “hay”. On a dry matter basis, cattle livestock eat more silage than hay. Silage or haylage is made from direct-cut alfalfa.

Alfalfa (Medicago saliva) is a forage legume often used for animal feed, especially dairy cattle. As used herein, the term “alfalfa” means any Medicago species, including, but not limited to, M. saliva, M. murex, M. falcata, M. prostrata, and M. truncatula. Thus, as used herein, the term “alfalfa” means any type of alfalfa including, but is not limited to, any alfalfa commonly referred to as cultivated alfalfa, diploid alfalfa, glandular alfalfa, purple-flowered alfalfa, sickle alfalfa, variegated alfalfa, wild alfalfa, or yellow-flowered alfalfa.

Analysis of the DNA sequence of the strain of Chlorella sp. described herein was done in the NCBI 18s rDNA reference database at the Culture Collection of Algae at the University of Cologne (CCAC) and showed substantial similarity (i.e., greater than 95%) with multiple known strains of Chlorella and Micractinium. Those of skill in the art will recognize that Chlorella and Micractinium appear closely related in many taxonomic classification trees for microalgae, and strains and species may be re-classified from time to time within the Chlorella and Micractinium genera. As would be understood in the art, the reclassification of various taxa is not unusual, and occurs as developments in science are made. Any disclosure in the specification regarding the classification of exemplary species or strains should be viewed in light of such developments. While the exemplary microalgae strain is referred to in the instant specification as Chlorella, it is recognized that microalgae strains in related taxonomic classifications with similar characteristics to the exemplary microalgae strain would reasonably be expected to produce similar results. Accordingly, any mention of Chlorella herein should be understood to include Micractinium species genetically and morphologically similar to species classified within the genus Chlorella as of the filing date.

Taxonomic classification has been in flux for organisms in the genus Schizochytrium. Some organisms previously classified as Schizochytrium have been reclassified as Aurantiochytrium, Thraustochytrium, or Oblongichytrium. See Yokoyama et al. Taxonomic rearrangement of the genus Schizochytrium sensu lato based on morphology, chemotaxonomic characteristics, and 18S rRNA gene phylogeny (Thrausochytriaceae, Labyrinthulomycetes): emendation for Schizochytrium and erection of Aurantiochytrium and Oblongichytrium gen. nov. Mycoscience (2007) 48:199-211. Those of skill in the art will recognize that Schizochytrium, Aurantiochytrium, Thraustochytrium, and Oblongichytrium appear closely related in many taxonomic classification trees for microalgae, and strains and species may be re-classified from time to time. Thus, for references throughout the instant specification for Schizochytrium, it is recognized that microalgae strains in related taxonomic classifications with similar characteristics to Schizochytrium, such as Aurantiochytrium, would reasonably be expected to produce similar results.

By artificially controlling aspects of the microalgae culturing process such as the organic carbon feed (e.g., acetic acid, acetate), oxygen levels, pH, and light, the culturing process differs from the culturing process that microalgae experiences in nature. In addition to controlling various aspects of the culturing process, intervention by human operators or automated systems occurs during the non-axenic mixotrophic culturing of microalgae through contamination control methods to prevent the microalgae from being overrun and outcompeted by contaminating organisms (e.g., fungi, bacteria). Contamination control methods for microalgae cultures are known in the art and such suitable contamination control methods for non-axenic mixotrophic microalgae cultures are disclosed in W02014/074769A2 (Ganuza, et al.), hereby incorporated by reference. By intervening in the microalgae culturing process, the impact of the contaminating microorganisms can be mitigated by suppressing the proliferation of containing organism populations and the effect on the microalgal cells (e.g., lysing, infection, death, clumping). Thus, through artificial control of aspects of the culturing process and intervening in the culturing process with contamination control methods, the microalgae culture produced as a whole and used in the described inventive compositions differs from the culture that results from a microalgae culturing process that occurs in nature.

In some embodiments and Examples below, the microalgae composition may be referred to as PHYCOTERRA®, PHYCOTERRA® ORGANIC, PHYCOTERRA® ST or PHYCOTERRA® FX. The PHYCOTERRA®, PHYCOTERRA® ORGANIC, PHYCOTERRA® ST or PHYCOTERRA® FX Chlorella microalgae composition is a microalgae composition comprising Chlorella sp. The PHYCOTERRA® and PHYCOTERRA® ORGANIC products contain whole cell Chlorella biomass while the PHYCOTERRA® ST and PHYCOTERRA® FX contain lysed cell Chlorella biomass. The PHYCOTERRA®Chlorella microalgae composition treatments were prepared by growing the Chlorella in non-axenic acetic acid supplied mixotrophic conditions, increasing the concentration of Chlorella using a centrifuge, pasteurizing the concentrated Chlorella at between 65° C.-75° C. for between 90-150 minutes, adding potassium sorbate and phosphoric acid to stabilize the pH of the Chlorella, and then adjusting the whole biomass treatment to the desired concentration. The PHYCOTERRA® Chlorella microalgae composition may comprise approximately 10% w/w of Chlorella microalgae cells. Furthermore, the PHYCOTERRA® Chlorella microalgae composition may comprise between approximately 0.3% potassium sorbate and between approximately 0.5%-1.5% phosphoric acid to stabilize the pH of the Chlorella to between 3.0-4.0 and 88.2%-89.2% water. It should be clearly understood, however, that other variations of the PHYCOTERRA® Chlorella microalgae composition, including variations in the microalgae strains, variations in the stabilizers, and/or variations in the % composition of each component may be used and may achieve similar results.

In some embodiments and Examples below, the microalgae composition may be an OMRI certified microalgae composition referred to as TERRENE®. The OMRI certified TERRENE® Chlorella microalgae composition is a microalgae composition comprising Chlorella. The OMRI certified TERRENE® Chlorella microalgae composition treatments were prepared by growing the Chlorella in non-axenic acetic acid supplied mixotrophic conditions, increasing the concentration of Chlorella using a centrifuge, pasteurizing the concentrated Chlorella at between 65° C.-75° C. for between 90-150 minutes, adding citric acid to stabilize the pH of the Chlorella, and then adjusting the whole biomass treatment to the desired concentration. The OMRI certified TERRENE® Chlorella microalgae composition may comprise approximately 10% w/w of Chlorella microalgae cells. Furthermore, the OMRI certified TERRENE® Chlorella microalgae composition may comprise between approximately 0.5%-2.0% citric acid to stabilize the pH of the Chlorella to between 3.0-4.0 and 88%-89.5% water. It should be clearly understood, however, that other variations of the OMRI certified TERRENE® Chlorella microalgae composition, including variations in the microalgae strains, variations in the stabilizers, and/or variations in the % composition of each component may be used and may achieve similar results.

The microalgae compositions described herein are suitable for enhancing harvest yields and for improving the quality of the harvested material.

A composition comprising microalgae can be stabilized by heating and cooling in a pasteurization process. In certain aspects, the active ingredients of the microalgae based compositions maintain effectiveness in enhancing at least one characteristic of a plant after being subjected to the heating and cooling of a pasteurization process. In other embodiments, compositions with whole cells or processed cells (e.g., dried, lysed, extracted) of microalgae cells may not need to be stabilized by pasteurization. For example, microalgae cells that have been processed, such as by drying, lysing, and extraction, or extracts can include such low levels of bacteria that a composition can remain stable without being subjected to the heating and cooling of a pasteurization process.

In some embodiments, the composition is lysed. Lysing is a technique where the cell membrane of a cell is ruptured, which releases lysate, the fluid contents of lysed cells, from the cells. As an example, the lysing process can comprise anything suitable that ruptures a cell membrane. For example, a bead mill may be used for lysing, where feedstock biomass solids can be dispersed and wetted (e.g., placed into a liquid phase). In this example the bead mill can utilize ceramic, glass, or metal beats (e.g., of a suitable size for the desired result) disposed in a chamber, such as a rotating cylinder, to collide with and mechanically macerate the solid biomass in the mill, which can help rupture the cell walls (e.g., the hydrogen bonds that hold together a cell membrane). Accordingly, in this example, the whole biomass may be lysed with water at cooler temperatures, with the resulting lysate comprising lipids in the form of an oil, biomass cell contents and unbroken biomass solid (e.g., non-target portion of biomass), and water.

In another aspect, the biomass is lysed using a shear mill. A shear mill utilizes a rotating impeller or high-speed rotor to create flow and shear of its contents. This causes the solid particles, such as biomass solid, to rupture due to shear stress.

In another aspect, the biomass is lysed using a pulsed electron field (PEF), high pressure homogenization, enzymes, and/or a chemical means (e.g., with a solvent).

### Microalgae

Non-limiting examples of microalgae that can be used in the compositions, mixtures, and methods of the invention are members of one of the following divisions: Chlorophyta, Cyanophyta (Cyanobacteria), and Heterokontophyta. In certain embodiments, the microalgae used in the compositions, mixtures, and methods of the invention are members of one of the following classes: Bacillariophyceae, Eustigmatophyceae, and Chrysophyceae. In certain embodiments, the microalgae used in the compositions and methods of the invention are members of one of the following genera: Nannochloropsis, Chlorella, Desmodesmus, Dunaliella, Scenedesmus, Spirulina, Chlamydomonas, Galdieria, Isochrysis, Porphyridium, Schizochytrium, Tetraselmis, Thraustochytrium, Botryococcus, and Haematococcus.

Non-limiting examples of microalgae species that can be used in the compositions, mixtures, and methods of the present invention include: Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Aurantiochytrium, sp. Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomonas sp., Chlamydomas perigranulata, Chlorella anitrata, Chlorella antarctica, Chlorella aureoviridis, Chlorella Candida, Chlorella capsulate, Chlorella desiccate, Chlorella ellipsoidea, Chlorella emersonii, Chlorellafusca, Chlorella fusca var. vacuolate, Chlorella glucotropha, Chlorella infusionum, Chlorella infusiomum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Desmodesmus sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Gleocapsa sp., Gloeothamnion sp., Haematococcus pluvialis, Hymenomonas sp., Isochrysis aff galbana, Isochrysis galbana, Lepocinclis, Micractinium, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Porphyridium, Platymonas sp., Pleurochrysis camerae, Pleurochrysis dentate, Pleurochrysis sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, Thraustochytrium sp., and Viridiellafridericiana.

### Methods of Application

In some embodiments, the composition comprising a culture of microalgae can include 2.5-30% solids by weight of microalgae cells (i.e., 2.5-30 g of microalgae cells/100 mL of the composition). In some embodiments, the composition can include 2.5-5% solids by weight of microalgae cells (i.e., 2.5-5 g of microalgae cells/100 mL of the composition). In some embodiments, the composition can include 5-20% solids by weight of microalgae cells. In some embodiments, the composition can include 5-15% solids by weight of microalgae cells. In some embodiments, the composition can include 5-10% solids by weight of microalgae cells. In some embodiments, the composition can include 10-20% solids by weight of microalgae cells. In some embodiments, the composition can include 10-20% solids by weight of microalgae cells. In some embodiments, the composition can include 20-30% solids by weight of microalgae cells. In some embodiments, further dilution of the microalgae cells percent solids by weight can occur before application for low concentration applications of the composition.

In some embodiments, the composition can include less than 1% by weight of microalgae biomass or extracts (i.e., less than 1 g of microalgae derived product/100 mL of the composition). In some embodiments, the composition can include less than 0.9% by weight of microalgae biomass or extracts. In some embodiments, the composition can include less than 0.8% by weight of microalgae biomass or extracts. In some embodiments, the composition can include less than 0.7% by weight of microalgae biomass or extracts. In some embodiments, the composition can include less than 0.6% by weight of microalgae biomass or extracts. In some embodiments, the composition can include less than 0.5% by weight of microalgae biomass or extracts. In some embodiments, the composition can include less than 0.4% by weight of microalgae biomass or extracts. In some embodiments, the composition can include less than 0.3% by weight of microalgae biomass or extracts. In some embodiments, the composition can include less than 0.2% by weight of microalgae biomass or extracts. In some embodiments, the composition can include less than 0.1% by weight of microalgae biomass or extracts. In some embodiments, the composition can include at least 0.0001% by weight of microalgae biomass or extracts. In some embodiments, the composition can include at least 0.001% by weight of microalgae biomass or extracts. In some embodiments, the composition can include at least 0.01% by weight of microalgae biomass or extracts. In some embodiments, the composition can include at least 0.1% by weight of microalgae biomass or extracts. In some embodiments, the composition can include 0.0001-1% by weight of microalgae biomass or extracts. In some embodiments, the composition can include 0.0001-0.001% by weight of microalgae biomass or extracts. In some embodiments, the composition can include 0.001-0.01% by weight of microalgae biomass or extracts. In some embodiments, the composition can include 0.01-0.1% by weight of microalgae biomass or extracts. In some embodiments, the composition can include 0.1-1% by weight of microalgae biomass or extracts.

In some embodiments, an application concentration of 0.1% of microalgae biomass or extract equates to 0.04 g of microalgae biomass or extract in 40 mL of a composition. While the desired application concentration to a plant can be 0.1% of microalgae biomass or extract, the composition can be packaged as a 10% concentration (0.4 mL in 40 mL of a composition). Thus, a desired application concentration of 0.1% would require 6,000 mL of the 10% microalgae biomass or extract in the 100 gallons of water applied to the assumption of 15,000 plants in an acre, which is equivalent to an application rate of about 1.585 gallons per acre. In some embodiments, a desired application concentration of 0.01% of microalgae biomass or extract using a 10% concentration composition equates to an application rate of about 0.159 gallons per acre. In some embodiments, a desired application concentration of 0.001% of microalgae biomass or extract using a 10% concentration composition equates to an application rate of about 0.016 gallons per acre. In some embodiments, a desired application concentration of 0.0001% of microalgae biomass or extract using a 10% concentration composition equates to an application rate of about 0.002 gallons per acre.

In another non-limiting embodiment, correlating the application of the microalgae biomass or extract on a per plant basis using the assumption of 15,000 plants per acre, the composition application rate of 1 gallon per acre is equal to about 0.25 mL per plant=0.025 g per plant=25 mg of microalgae biomass or extract per plant. The water requirement assumption of 100 gallons per acre is equal to about 35 mL of water per plant. Therefore, 0.025 g of microalgae biomass or extract in 35 mL of water is equal to about 0.071 g of microalgae biomass or extract per 100 mL of composition equates to about a 0.07% application concentration. In some embodiments, the microalgae biomass or extract based composition can be applied at a rate in a range as low as about 0.001-10 gallons per acre, or as high as up to 150 gallons per acre.

In some embodiments, the applications are performed using a 10% solids solution by weight microalgae composition. For greenhouse trials, the rates vary and essentially refer to how much volume of the 10% solids solution are added in a given volume of water (e.g. 2.5% v/v-5.0% v/v).

Additionally, the present invention is directed to a method of treating a plant, a plant part, such as a seed, root, rhizome, corm, bulb, or tuber, and/or a locus on which or near which the plant or the plant parts grow, such as soil, to enhance crop yield and/or the quality of a harvested crop.

The compositions disclosed herein may be applied in any desired manner, such as in the form of a seed coating, soil drench, and/or directly in-furrow and/or as a foliar spray and applied either pre-emergence, post-emergence or both. In other words, the compositions can be applied to the seed, the plant or to the soil wherein the plant is growing or wherein it is desired to grow (plant's locus of growth).

In some embodiments, the microalgae based composition may be applied to soil, seeds, and plants in an in-furrow application. An application of the microalgae based composition in-furrow requires a low amount of water and targets the application to a small part of the field. The application in-furrow also concentrates the application of the compositions at a place where the seedling radicles and roots will pick up the material in the compositions or make use of captured nutrients, including phytohormones.

In some embodiments, the microalgae based composition may be applied to soil, seeds, and plants as a side dress application. One of the principals of plant nutrient applications is to concentrate the nutrients in an area close to the root zone so that the plant roots will encounter the nutrients as the plant grows. Side-dress applications use a “knife” that is inserted into the soil and delivers the nutrients around 2 inches along the row and about 2 inches or more deep. Side-dress applications are made when the plants are young and prior to flowering to support yield. Side-dress applications can only be made prior to planting in drilled crops, i.e. wheat and other grains, and alfalfa, but in row crops such as peppers, corn, tomatoes they can be made after the plants have emerged.

In some embodiments, the microalgae based composition may be applied to soil, seeds, and plants through a drip system. Depending on the soil type, the relative concentrations of sand, silt and clay, and the root depth, the volume that is irrigated with a drip system may be about 3 of the total soil volume. The soil has an approximate weight of 4,000,000 lbs. per acre one foot deep. Because the roots grow where there is water, the plant nutrients in the microalgae based composition would be delivered to the root system where the nutrients will impact most or all of the roots. Experimental testing of different application rates to develop a rate curve would aid in determining the optimum rate application of the compositions in a drip system application.

In some embodiments, the microalgae based composition may be applied to soil, seeds, and plants through a pivot irrigation application. The quantity and frequency of water delivered over an area by a pivot irrigation system is dependent on the soil type and crop. Applications may be 0.5 inch or more and the exact demand for water can be quantitatively measured using soil moisture gauges. For crops such as alfalfa that are drilled in (very narrow row spacing), the roots occupy the entire soil area. Penetration of the soil by the microalgae based composition may vary with a pivot irrigation application, but would be effective as long as the application can target the root system of the plants. In some embodiments, the microalgae based composition may be applied in a broadcast application to plants with a high concentration of plants and roots, such as row crops.

In certain aspects, the microalgae based composition are applied at 0.1-150 gallons per acre, 0.1-50 gallons per acre, or 0.1-10 gallons per acre.

The present invention involves the use of a microalgae composition. Microalgae compositions, methods of preparing microalgae compositions, and methods of applying the microalgae compositions to plants are disclosed in WO 2017/218896 A1 (Shinde et al.) entitled “Microalgae-Based Composition, and Methods of its Preparation and Application to Plants,” which is incorporated herein in full by reference. In one or more embodiments, the microalgae composition may comprise approximately 10%/6-10.5% w/w of Chlorella microalgae cells. In one or more embodiments, the microalgae composition may also comprise one of more stabilizers, such as potassium sorbate, phosphoric acid, ascorbic acid, sodium benzoate, citric acid, or the like, or any combination thereof. For example, in one or more embodiments, the microalgae composition may comprise approximately 0.3% w/w of potassium sorbate or another similar compound to stabilize its pH and may further comprise approximately 0.5-1.5% w/w phosphoric acid or another similar compound to prevent the growth of contaminants. As a further example, in one or more embodiments where it is desired to use an OMRI (Organic Materials Review Institute) certified organic composition, the microalgae composition may comprise 1.0-2.0% w/w citric acid to stabilize its pH, and may not contain potassium sorbate or phosphoric acid. In one or more embodiments, the pH of the microalgae composition may be stabilized to between 3.0-4.0.

In some embodiments, the composition is a liquid and substantially includes water. In some embodiments, the composition can include 70-99% water. In some embodiments, the composition can include 85-95% water. In some embodiments, the composition can include 70-75% water. In some embodiments, the composition can include 75-80% water. In some embodiments, the composition can include 80-85% water. In some embodiments, the composition can include 85-90% water. In some embodiments, the composition can include 90-95% water. In some embodiments, the composition can include 95-99% water. The liquid nature and high-water content of the composition facilitates administration of the composition in a variety of manners, such as but not limit to: flowing through an irrigation system, flowing through an above ground drip irrigation system, flowing through a buried drip irrigation system, flowing through a central pivot irrigation system, sprayers, sprinklers, and water cans.

In some embodiments, administration of the microalgae based composition to soil, a seed or plant can be in an amount effective to produce an enhanced characteristic in plants compared to a substantially identical population of untreated seeds or plants. Such enhanced characteristics can include accelerated seed germination, accelerated seedling emergence, improved seedling emergence, improved leaf formation, accelerated leaf formation, improved plant maturation, accelerated plant maturation, increased plant yield, increased plant growth, increased plant quality, increased plant health, increased fruit yield, increased fruit sweetness, increased fruit growth, and increased fruit quality. Non-limiting examples of such enhanced characteristics can include accelerated achievement of the hypocotyl stage, accelerated protrusion of a stem from the soil, accelerated achievement of the cotyledon stage, accelerated leaf formation, increased marketable plant weight, increased marketable plant yield, increased marketable fruit weight, increased production plant weight, increased production fruit weight, increased utilization (indicator of efficiency in the agricultural process based on ratio of marketable fruit to unmarketable fruit), increased chlorophyll content (indicator of plant health), increased plant weight (indicator of plant health), increased root weight (indicator of plant health), increased shoot weight (indicator of plant health), increased plant height, increased thatch height, increased resistance to salt stress, increased plant resistance to heat stress (temperature stress), increased plant resistance to heavy metal stress, increased plant resistance to drought, increased plant resistance to disease, improved color, reduced insect damage, reduced blossom end rot, and reduced sun bum. Such enhanced characteristics can occur individually in a plant, or in combinations of multiple enhanced characteristics.

In some embodiments, the microalgae based composition can be administered before the seed is planted. In some embodiments, the microalgae based composition can be administered at the time the seed is planted. In some embodiments, the microalgae based composition can be applied by dip treatment of the roots. In some embodiments, the microalgae based composition can be administered to plants that have emerged from the ground.

In another non-limiting embodiment, the administration of the microalgae based composition can include contacting the soil in the immediate vicinity of the planted seed with an effective amount of the composition. In some embodiments, the microalgae based composition can be supplied to the soil by injection into a low volume irrigation system, such as but not limited to a drip irrigation system supplying water beneath the soil through perforated conduits or at the soil level by fluid conduits hanging above the ground or protruding from the ground. In some embodiments, the microalgae based composition can be supplied to the soil by a soil drench method wherein the composition is poured on the soil.

The microalgae based composition can be diluted to a lower concentration for an effective amount in a soil application by mixing a volume of the composition in a volume of water. The percent solids of microalgae sourced components resulting in the diluted composition can be calculated by the multiplying the original concentration in the composition by the ratio of the volume of the composition to the volume of water. Alternatively, the grams of microalgae sourced components in the diluted composition can be calculated by the multiplying the original grams of microalgae sourced components per 100 mL by the ratio of the volume of the composition to the volume of water.

The rate of application of the microalgae based composition at the desired concentration can be expressed as a volume per area. In some embodiments, the rate of application of the microalgae based composition in a soil application can include a rate in the range of 50-150 gallons/acre. In some embodiments, the rate of application of the microalgae based composition in a soil application can include a rate in the range of 75-125 gallons/acre. In some embodiments, the rate of application of the microalgae based composition in a soil application can include a rate in the range of 50-75 gallons/acre. In some embodiments, the rate of application of the microalgae based composition in a soil application can include a rate in the range of 75-100 gallons/acre. In some embodiments, the rate of application of the microalgae based composition in a soil application can include a rate in the range of 100-125 gallons/acre. In some embodiments, the rate of application of the microalgae based composition in a soil application can include a rate in the range of 125-150 gallons/acre.

In some embodiments, the rate of application of the microalgae based composition in a soil application can include a rate in the range of 10-50 gallons/acre. In some embodiments, the rate of application of the microalgae based composition in a soil application can include a rate in the range of 10-20 gallons/acre. In some embodiments, the rate of application of the microalgae based composition in a soil application can include a rate in the range of 20-30 gallons/acre. In some embodiments, the rate of application of the microalgae based composition in a soil application can include a rate in the range of 30-40 gallons/acre. In some embodiments, the rate of application of the microalgae based composition in a soil application can include a rate in the range of 40-50 gallons/acre.

In some embodiments, the rate of application of the microalgae based composition in a soil application can include a rate in the range of 0.01-10 gallons/acre. In some embodiments, the rate of application of the microalgae based composition in a soil application can include a rate in the range of 0.01-0.1 gallons/acre. In some embodiments, the rate of application of the microalgae based composition in a soil application can include a rate in the range of 0.1-1.0 gallons/acre. In some embodiments, the rate of application of the microalgae based composition in a soil application can include a rate in the range of 1-2 gallons/acre. In some embodiments, the rate of application of the microalgae based composition in a soil application can include a rate in the range of 2-3 gallons/acre. In some embodiments, the rate of application of the microalgae based composition in a soil application can include a rate in the range of 3-4 gallons/acre. In some embodiments, the rate of application of the microalgae based composition in a soil application can include a rate in the range of 4-5 gallons/acre. In some embodiments, the rate of application of the microalgae based composition in a soil application can include a rate in the range of 5-10 gallons/acre.

In some embodiments, the rate of application of the microalgae based composition in a soil application can include a rate in the range of 2-20 liters/acre. In some embodiments, the rate of application of the microalgae based composition in a soil application can include a rate in the range of 3.7-15 liters/acre. In some embodiments, the rate of application of the microalgae based composition in a soil application can include a rate in the range of 2-5 liters/acre. In some embodiments, the rate of application of the microalgae based composition in a soil application can include a rate in the range of 5-10 liters/acre. In some embodiments, the rate of application of the microalgae based composition in a soil application can include a rate in the range of 10-15 liters/acre. In some embodiments, the rate of application of the microalgae based composition in a soil application can include a rate in the range of 15-20 liters/acre.

### Plants

Many plants can benefit from the application of compositions that provide a bio-stimulatory effect. Non-limiting examples of plant families that can benefit from such compositions include plants from the following: Solanaceae, Fabaceae (Leguminosae), Poaceae, Roasaceae, Vitaceae, Brassicaeae (Cruciferae), Caricaceae, Malvaceae, Sapindaceae, Anacardiaceae, Rutaceae, Moraceae, Convolvulaceae, Lamiaceae, Verbenaceae, Pedaliaceae, Asteraceae (Compositae), Apiaceae (Umbelliferae), Araliaceae, Oleaceae, Ericaceae, Actinidaceae, Cactaceae, Chenopodiaceae, Polygonaceae, Theaceae, Lecythidaceae, Rubiaceae, Papveraceae, Illiciaceae Grossulariaceae, Myrtaceae, Juglandaceae, Bertulaceae, Cucurbitaceae, Asparagaceae (Liliaceae), Alliaceae (Liliceae), Bromeliaceae, Zingieraceae, Muscaceae, Areaceae, Dioscoreaceae, Myristicaceae, Annonaceae, Euphorbiaceae, Lauraceae, Piperaceae, Proteaceae, and Cannabaceae.

The Solanaceae plant family includes a large number of agricultural crops, medicinal plants, spices, and ornamentals in its over 2,500 species. Taxonomically classified in the Plantae kingdom, Tracheobionta (subkingdom), Spermatophyta (superdivision), Magnoliophyta (division), Manoliopsida (class), Asteridae (subclass), and Solanales (order), the Solanaceae family includes, but is not limited to, potatoes, tomatoes, eggplants, various peppers, tobacco, and petunias. Plants in the Solanaceae can be found on all the continents, excluding Antarctica, and thus have a widespread importance in agriculture across the globe.

The Rosaceae plant family includes flowering plants, herbs, shrubs, and trees. Taxonomically classified in the Plantae kingdom, Tracheobionta (subkingdom), Spermatophyta (superdivision), Magnoliophyta (division), Magnoliopsida (class), Rosidae (subclass), and Rosales (order), the Rosaceae family includes, but is not limited to, almond, apple, apricot, blackberry, cherry, nectarine, peach, plum, raspberry, strawberry, and quince.

The Fabaceae plant family (also known as the Leguminosae) comprises the third largest plant family with over 18,000 species, including a number of important agricultural and food plants. Taxonomically classified in the Plantae kingdom, Tracheobionta (subkingdom), Spermatophyta (superdivision), Magnoliophyta (division), Manoliopsida (class), Rosidae (subclass), and Fabales (order), the Fabaceae family includes, but is not limited to, soybeans, beans, green beans, peas, chickpeas, alfalfa, peanuts, sweet peas, carob, and liquorice. Plants in the Fabaceae family can range in size and type, including but not limited to, trees, small annual herbs, shrubs, and vines, and typically develop legumes. Plants in the Fabaceae family can be found on all the continents, excluding Antarctica, and thus have a widespread importance in agriculture across the globe. Besides food, plants in the Fabaceae family can be used to produce natural gums, dyes, and ornamentals.

The Poaceae plant family supplies food, building materials, and feedstock for fuel processing. Taxonomically classified in the Plantae kingdom, Tracheobionta (subkingdom), Spermatophyta (superdivision), Magnoliophyta (division), Liliopsida (class), Commelinidae (subclass), and Cyperales (order), the Poaceae family includes, but is not limited to, flowering plants, grasses, and cereal crops such as barely, corn, lemongrass, millet, oat, rye, rice, wheat, sugarcane, and sorghum. Types of turf grass found in Arizona include, but are not limited to, hybrid Bermuda grasses (e.g., 328 tifgrn, 419 tifway, tif sport).

The Vitaceae plant family includes flowering plants and vines. Taxonomically classified in the Plantae kingdom, Tracheobionta (subkingdom), Spermatophyta (superdivision), Magnoliophyta (division), Magnoliopsida (class), Rosidae (subclass), and Rhammales (order), the Vitaceae family includes, but is not limited to, grapes.

Compositions and methods according to the invention can be used for growing a broad variety of crops, such as potatoes, sugar beets, wheat, barley, rye, oat, sorghum, rice, maize, cotton, rapeseed, oilseed rape, canola, soybeans, peas, field beans, sunflowers, sugar cane; cucumbers, tomatoes, onions, leeks, lettuce, squashes; corn, wheat, soy, cereals, and row crops.

In certain aspects, the compositions and methods of the present invention are used with wheat plants or wheat seed. Wheat, genus Triticum, exists as a number of types. Durum wheat (T. durum) and emmer wheat are tetraploid wheats. Hexaploid wheats include spelt wheat, compact wheat, and bread wheat. Wheat plants include varieties of winter and spring wheat, such as hard red winter wheat, soft red winter wheat, hard white winter wheat, soft white winter wheat, Durum wheat, and hard red spring wheat.

### Improved Crop Quality Characteristics

The compositions and methods described herein can be used to enhance a number of quality characteristics of harvested crops including but not limited to individual crop weight, individual crop size, protein content, oil content, carbohydrate content, fiber content, lysine content, grain hardness, number of hard and vitreous kernels of amber color (HVAC), relative feed value (RFV), total digestible nutrients (TDN), crude protein (CP), nutritional quality, forage quality, and forage digestibility.

In certain aspects, the application of the culture of microalgae improves forage quality, forage digestibility, and/or forage production. In accordance with the disclosure, improved forage quality may be indicated by, for example, forage with an increased percentage of dry matter or crude protein, or a combination thereof; forage with a decreased percentage of acid detergent fiber, neutral detergent fiber, or acid detergent lignin, or a combination thereof, or any combination of the foregoing. In accordance with the disclosure, improved forage digestibility may be indicated by, for example, forage with an increased percentage of crude protein or neutral detergent fiber digestibility, or a combination thereof, or forage with a decreased percentage of acid detergent fiber, neutral detergent fiber, or acid detergent lignin, or any combination of the foregoing. In accordance with the disclosure, improved forage production may be indicated by, for example, an increased amount of the biomass to be harvested from an alfalfa plant, increased vigor, dry weight, fresh weight, or leaf to stem ratio, or a combination thereof.

In certain aspects, the compositions and methods described herein decrease grain or kernel damage, grain or kernel chalkiness, or the number of nut doubles.

The present invention is further illustrated by the following examples that should not be construed as limiting. The contents of all references, patents, and published patent applications cited throughout this application, as well as the Figures, are incorporated herein by reference in their entirety for all purposes.

### EXAMPLES

### Example 1. PHYCOTERRA® (Whole Cell Chlorella Microalgae) Improves Almond Quality

Nonpareil almond trees growing in sandy soil with an organic matter of about 0.7% were treated with PHYCOTERRA® (whole cell Chlorella microalgae) via fertigation at 1 qt/acre, 2 qt/acre, or 3 qt/acre with a total of four applications during the growing season. Untreated control almond trees (“Grower Standard”) were grown under the same conditions without application of PHYCOTERRA® (whole cell Chlorella microalgae). Sixth leaf almonds were harvested and evaluated for various quality parameters including average individual nut weight and percentage of almond doubles.

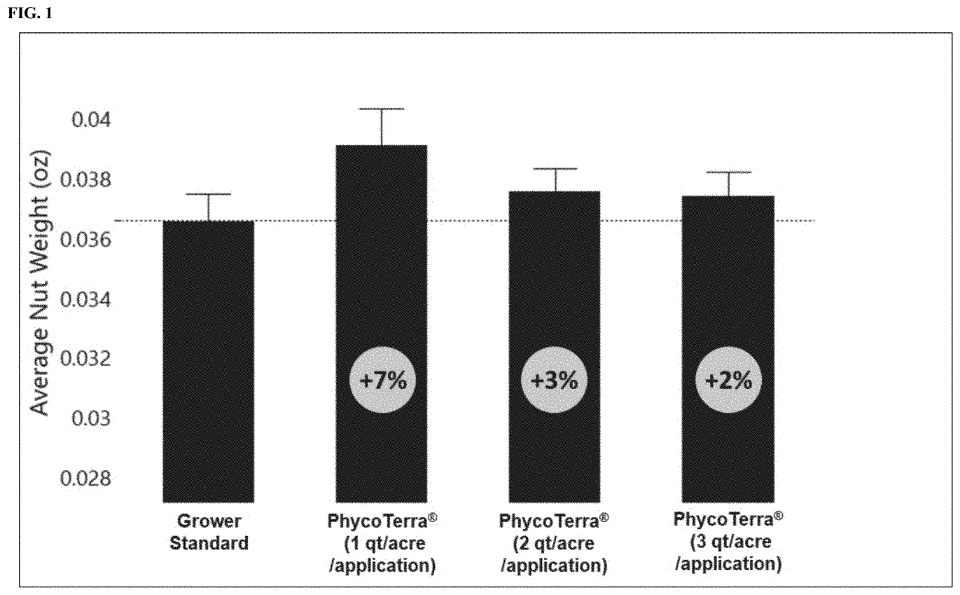

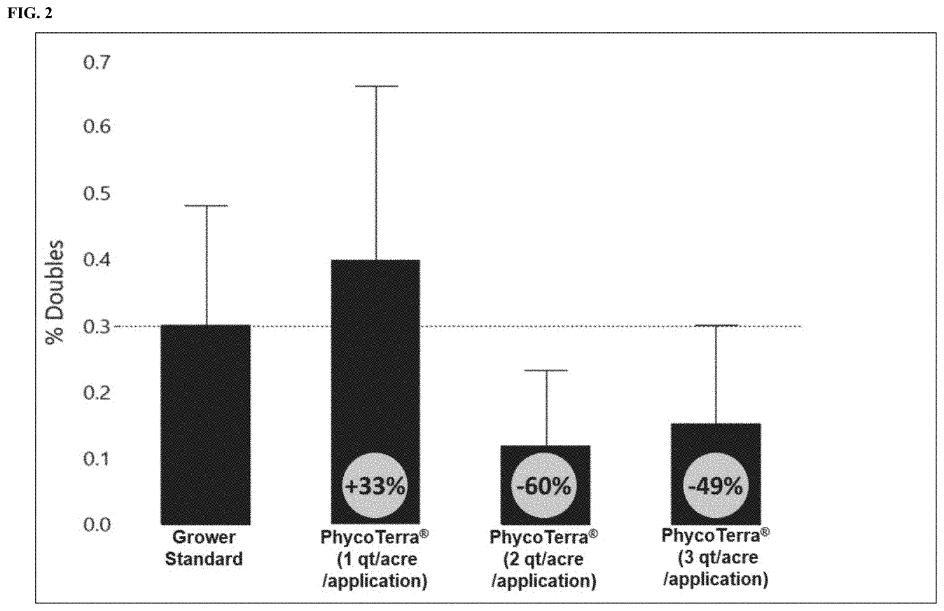

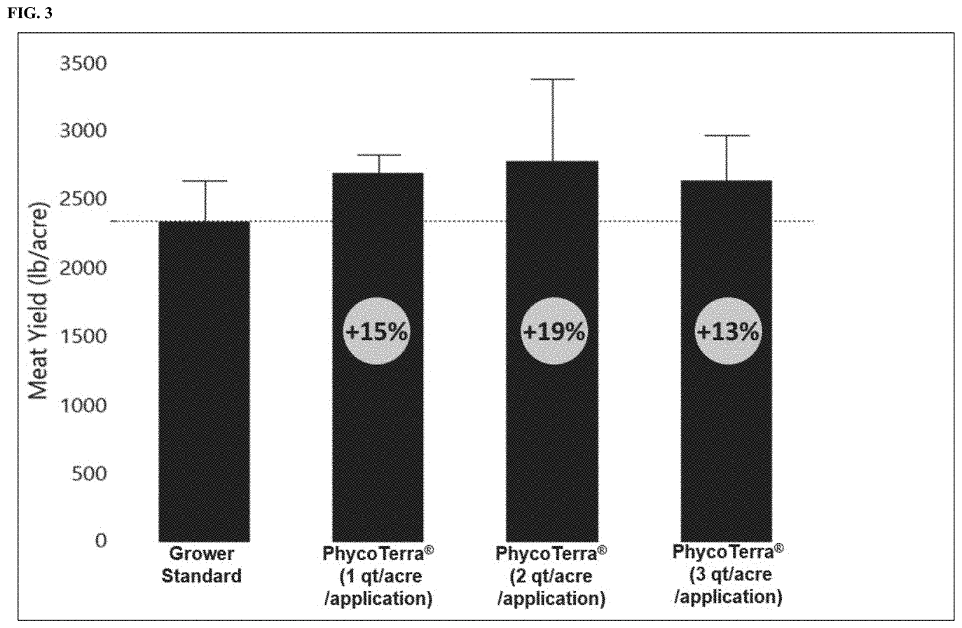

Application of PHYCOTERRA® (whole cell Chlorella microalgae) consistently increased the average individual nut weight by between 2% and 7% compared to the untreated control (see FIG. 1). At application rates of 2 qt/acre and 3 qt/acre, the relative percentage of doubles also dropped indicating an increase in almond quality (see FIG. 2). These increases in almond quality resulting from application of PHYCOTERRA® (whole cell Chlorella microalgae) were accompanied by an overall increase in almond meat yield (see FIG. 3).

### Example 2. PHYCOTERRA® (Whole Cell Chlorella Microalgae) and PHYCOTERRA® ST (Lysed Chlorella Microalgae) Enhance Protein Content and Overall Yield in Durum Wheat

A field trial was conducted with durum wheat in a geography with silty clay soil. Wheat plants were treated with PHYCOTERRA® ST (lysed Chlorella microalgae) alone or in combination with PHYCOTERRA® (whole cell Chlorella microalgae). PHYCOTERRA® ST (lysed Chlorella microalgae) was applied as a seed treatment at a rate of 5 ounces per hundred weight (oz/CWT), and PHYCOTERRA® (whole cell Chlorella microalgae) was applied at a rate of 2 qt/acre as a soil drench. A single application was made to plants, and a total of 36.1 acres were treated in the trial. Untreated control wheat plants (“Grower Standard”) were evaluated for comparison.

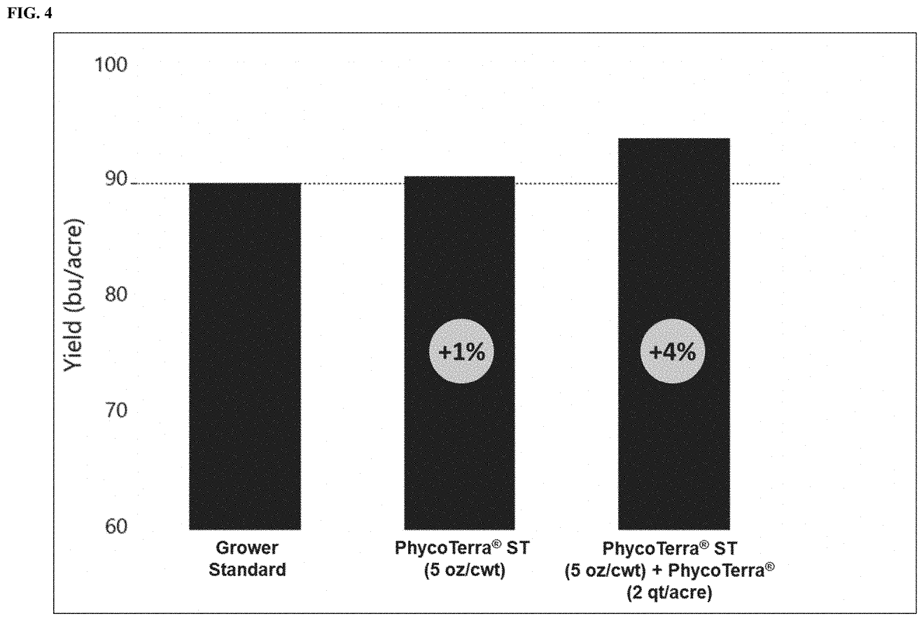

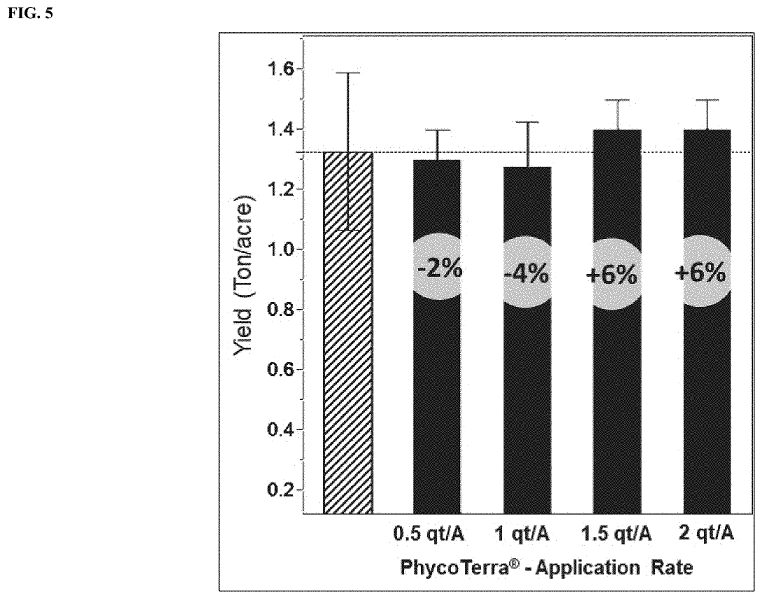

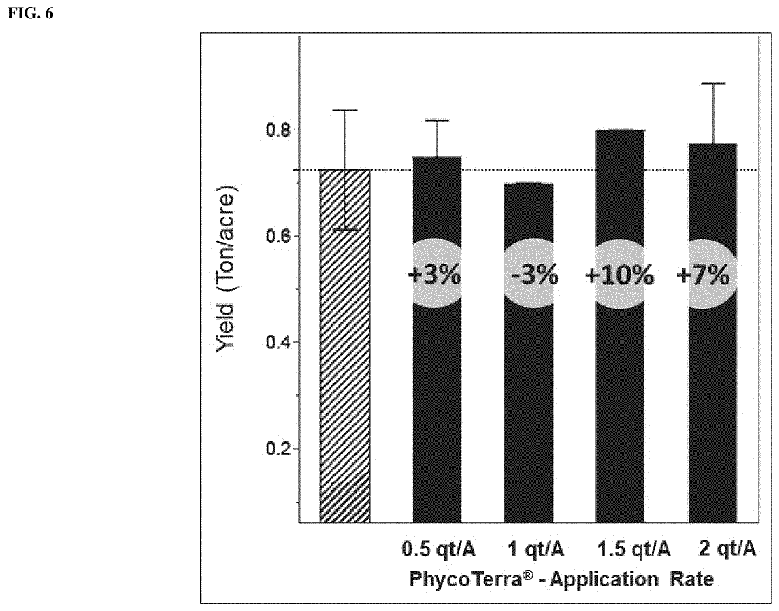

Treatment with PHYCOTERRA® ST (lysed Chlorella microalgae) alone improved the percentage of hard and vitreous kernels of amber color (HVAC) and the protein content of harvested wheat. The combination treatment including both PHYCOTERRA® ST (lysed Chlorella microalgae) and PHYCOTERRA® (whole cell Chlorella microalgae) further improved both these characteristics of wheat quality (see Table 1). The treated durum wheat also demonstrated increases in overall yield compared to untreated control wheat (see FIG. 4).

TABLE 1
Evaluation of hard and vitreous kernels of amber color
(HVAC) and protein content in durum wheat treated with
PHYCOTERRA ® ST (lysed Chlorella microalgae)
and PHYCOTERRA ® (whole cell Chlorella microalgae).

| | | | % Difference |
|---|---|---|---|
| | | | in Protein |
| | | | from Grower |
| Treatment | HVAC % | Protein % | Standard |
| Grower | 71% | 11.0% | — |
| Standard | | | |
| PhycoTerra ® ST | 75% | 11.5% | 5% |
| (5 oz/CWT) | | | |
| PhycoTerra ® ST | 86% | 12.3% | 12% |
| (5 oz/CWT) + | | | |
| PhycoTerra ® | | | |
| (1 qt/ac) | | | |

The improvement in the quality of harvested wheat results in greater profitability to growers. As an example, the prices offered for durum wheat at the time and location of this trial were USD $3.50/bu for durum wheat of under 85% HVAC and USD $5.25/bu for durum wheat of over 85% HVAC.

### Example 3. PHYCOTERRA® (Whole Cell Chlorella Microalgae) Increases the Relative Feed Value of Alfalfa

A field trial was conducted with alfalfa in a geography with clay loam soil. Alfalfa was treated with PHYCOTERRA® (whole cell Chlorella microalgae) at a rate of 0.5 qt/acre, 1 qt/acre, 1.5 qt/acre, or 2 qt/acre. A total offour applications per treatment group were made resulting in total application rates of 2 qt/acre/season, 4 qt/acre/season, or 6 qt/acre/season. PHYCOTERRA® (whole cell Chlorella microalgae) was applied via broadcast. Untreated control wheat plants (“Grower Standard”) were evaluated for comparison.

Hay was harvested 2-3 weeks after the product application. A first cut was evaluated for relative feed value (RFV) during the month of June, and a second cut was subsequently evaluated for RFV during the month of July. In both cuts, application of PHYCOTERRA® (whole cell Chlorella microalgae) increased the alfalfa quality parameter of RFV (see Tables 2-3). Application of PHYCOTERRA® (whole cell Chlorella microalgae) at rates of 1.5 qt/acre and 2 qt/acre also consistently increased the yield (ton/acre) ofalfalfa (see FIGS. 5 and 6).

TABLE 2
Evaluation of relative feed value (RFV) in alfalfa
treated with PHYCOTERRA ® (whole cell Chlorella
microalgae) after a first cut in the month of June.

| | | Point Difference | % Difference |
|---|---|---|---|
| | Relative Feed | RFV from Grower | from Grower |
| June Treatments | Value (RFV) | Standard | Standard |
| Grower | 91 | — | — |
| Standard | | | |
| PhycoTerra ® 2 qt/ | 108 | 17 | 19% |
| acre/season | | | |
| PhycoTerra ® 4 qt/ | 98 | 7 | 8% |
| acre/season | | | |
| PhycoTerra ® 6 qt/ | 104 | 13 | 14% |
| acre/season | | | |

TABLE 3
Evaluation of relative feed value (RFV) in alfalfa
treated with PHYCOTERRA ® (whole cell Chlorella
microalgae) after a second cut in the month of July.

| | | Point Difference | % Difference |
|---|---|---|---|
| | Relative Feed | RFV from Grower | from Grower |
| July Treatments | Value (RFV) | Standard | Standard |
| Grower | 134 | — | — |
| Standard | | | |
| PhycoTerra ® 2 qt/ | 149 | 15 | 11% |
| acre/season | | | |
| PhycoTerra ® 4 qt/ | 145 | 11 | 8% |
| acre/season | | | |
| PhycoTerra ® 6 qt/ | 139 | 5 | 4% |
| acre/season | | | |

The RFV, total digestible nutrients (TDN), crude protein (CP), and visual appearance are each quality parameters used to rate harvested alfalfa's quality as low, fair, good, premium, or supreme. This quality rating directly impacts the price available for the harvested alfalfa. Therefore, application of PHYCOTERRA® (whole cell Chlorella microalgae) increases not only the total yield of alfalfa but also the quality of the harvested hay to provide additional value to the grower.

### Example 4. PHYCOTERRA® (Whole Cell Chlorella Microalgae) Increases Oil Content in Canola

A field trial was conducted with canola in a geography with silty clay soil. Canola plants were treated with PHYCOTERRA® ST (lysed Chlorella microalgae) in combination with PHYCOTERRA® (whole cell Chlorella microalgae). PHYCOTERRA® ST (lysed Chlorella microalgae) was applied as a seed treatment at a rate of 5 ounces per hundred weight (oz/CWT), and PHYCOTERRA® (whole cell Chlorella microalgae) was applied as a soil drench at a rate of 2 qt/acre. A single application of each product was made with a total of 27.5 acres of canola treated. Untreated control wheat plants (“Grower Standard”) were evaluated for comparison.

At harvest, the total yield (bu/acre) and oil content in harvested canola were evaluated. Application of PHYCOTERRA® ST (lysed Chlorella microalgae) in combination with PHYCOTERRA® (whole cell Chlorella microalgae) to canola increased both the yield and the oil content compared to the untreated control canola (see Table 4).

TABLE 4
Evaluation of yield and oil content in canola treated with
PHYCOTERRA ® ST (lysed Chlorella microalgae) in
combination with PHYCOTERRA ® (whole cell Chlorella microalgae).

| | | | | % Change |
|---|---|---|---|---|
| | | % Change | | in Oil |
| | | in Yield vs. | | Content vs. |
| | Yield | Grower | % Oil | Grower |
| Treatment | (bu/acre) | Standard | Content | Standard |
| Grower | 44.1 | — | 45% | — |
| Standard | | | | |
| PhycoTerra ® ST | 44.9 | 2% | 46% | 2% |
| (5 oz/cwt) + | | | | |
| PhycoTerra ® | | | | |
| (2 qt/acre) | | | | |

A second canola field trial where PHYCOTERRA® (whole cell Chlorella microalgae) was applied at 1 qt/acre or 2 qt/acre confirmed this observation of increased oil content. Due to weather conditions, the harvest of canola took place two months later than usual. Despite these challenges, PHYCOTERRA® (whole cell Chlorella microalgae) improved the oil content in the harvested canola compared to the untreated control canola (see Table 5).

TABLE 5
Evaluation of oil content in canola
treated with PHYCOTERRA ® (whole
cell Chlorella microalgae).

| | | Percent Change |
|---|---|---|
| | | in Oil |
| | | Content vs |
| | Oil Content | Grower |
| Treatment | (%) | Standard |
| Grower | 44.4 | — |
| Standard | | |
| PhycoTerra ® | 45.5 | 2% |
| (1 qt/acre) | | |
| PhycoTerra ® | 47.4 | 7% |
| (2 qt/acre) | | |

### Example 5. PHYCOTERRA® (Whole Cell Chlorella Microalgae) Increases Protein Content in Corn

A field trial was conducted with corn in a geography with silty clay loam/clay loam soil. The corn was planted in 4.5-acre plots. Plants were treated with PHYCOTERRA® (whole cell Chlorella microalgae) at a rate of 1 qt/acre. A single application was made at V14 via Y-drop. Untreated control corn (“Grower Standard”) was evaluated for comparison.

At harvest, the treated and untreated control groups were evaluated for yield and grain protein content. Application of PHYCOTERRA® (whole cell Chlorella microalgae) to corn increased both the yield (bu/acre) and grain protein content compared to untreated control corn (see Table 6).

TABLE 6
Evaluation of yield (bu/acre) and grain protein in corn treated with
PHYCOTERRA ® (whole cell Chlorella microalgae).

| | | | | % Change |
|---|---|---|---|---|
| | | % Change | | in Protein |
| | | in Yield vs. | | Content vs. |
| | Yield | Grower | % Grain | Grower |
| Treatment | (bu/acre) | Standard | Protein | Standard |
| Grower | 208.0 | — | 7.9% | — |
| Standard | | | | |
| PhycoTerra ® | 212.4 | 2% | 8.2% | 4% |
| (1 qt/acre) | | | | |

### Example 6. PHYCOTERRA® (Whole Cell Chlorella Microalgae) Increases Protein Content in Soybean

A field trial was conducted with soybeans in a geography with silty loam soil having about 2.1% organic matter (OM). Soybean variety 44EB32 was used for the trial. Soybean plants were treated with PHYCOTERRA® FX (lysed Chlorella microalgae) at a rate of 1 qt/acre at planting. Untreated control soybeans (“Grower Standard”) were evaluated for comparison. All soybean plants were treated with a standard mixture of chemical fungicides.

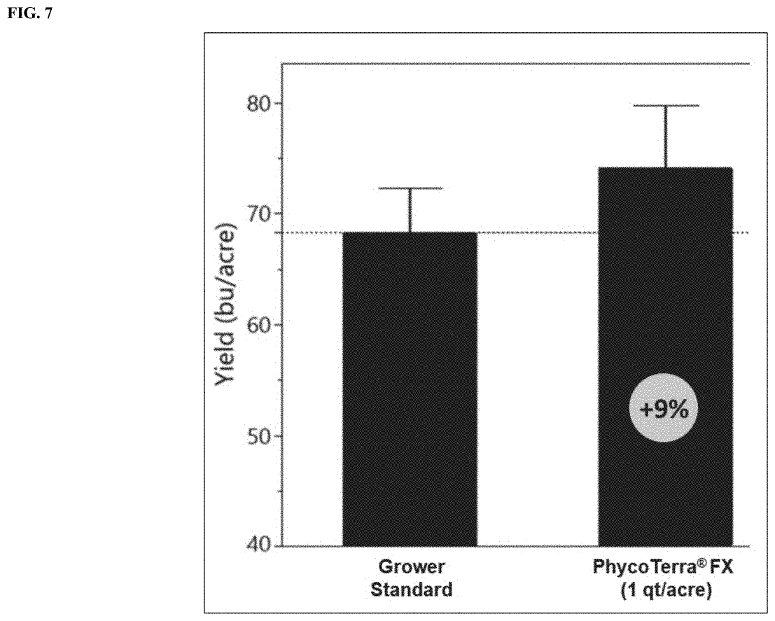

At harvest, the treated and untreated control groups were evaluated for yield and protein content. Application of PHYCOTERRA® FX (lysed Chlorella microalgae) to plants increased the protein content of harvested soybeans by 0.4% and the yield (bu/acre) by 9% (see FIG. 7) compared to untreated control soybeans.

### Example 7. PHYCOTERRA® (Whole Cell Chlorella Microalgae) Improves Fruit Size, Rind Thickness, and Flesh Color in Oranges

A field trial was conducted with navel orange trees in Exeter, Calif. with clay soil having 2% organic matter. The navel orange trees were about 26 years old. Trees were treated with PHYCOTERRA® (whole cell Chlorella microalgae) with six applications of 2 qt/acre both pre- and post-bloom and monthly during fruit development for an overall application rate of 12 qt/acre. Untreated control navel orange trees (“Grower Standard”) were evaluated for comparison.

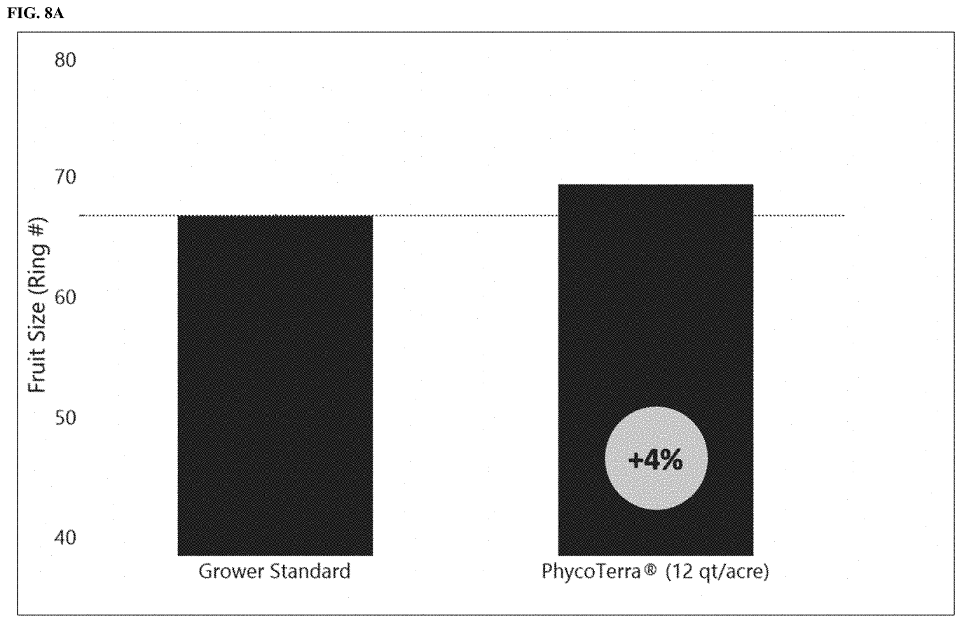

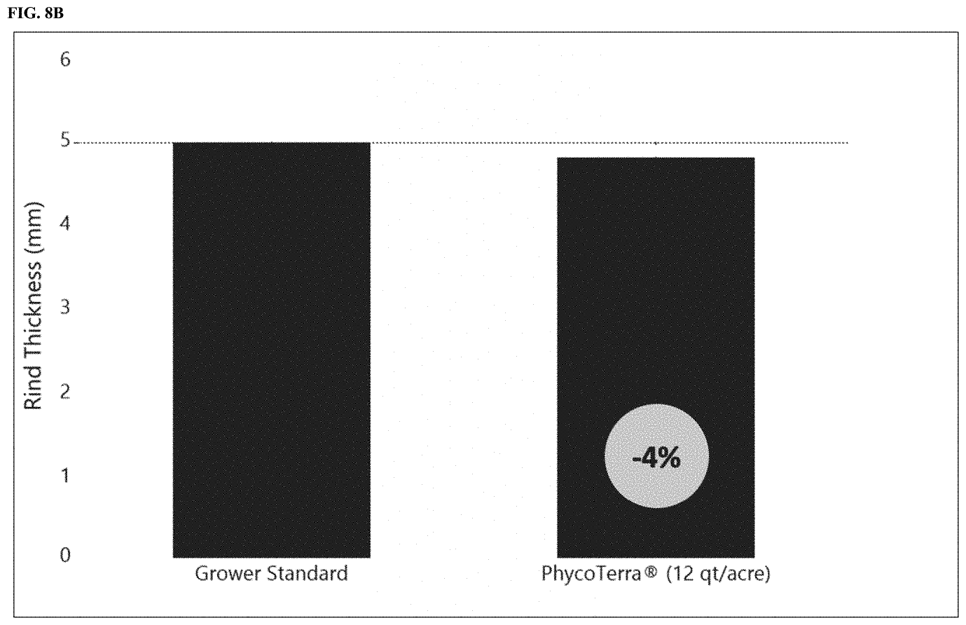

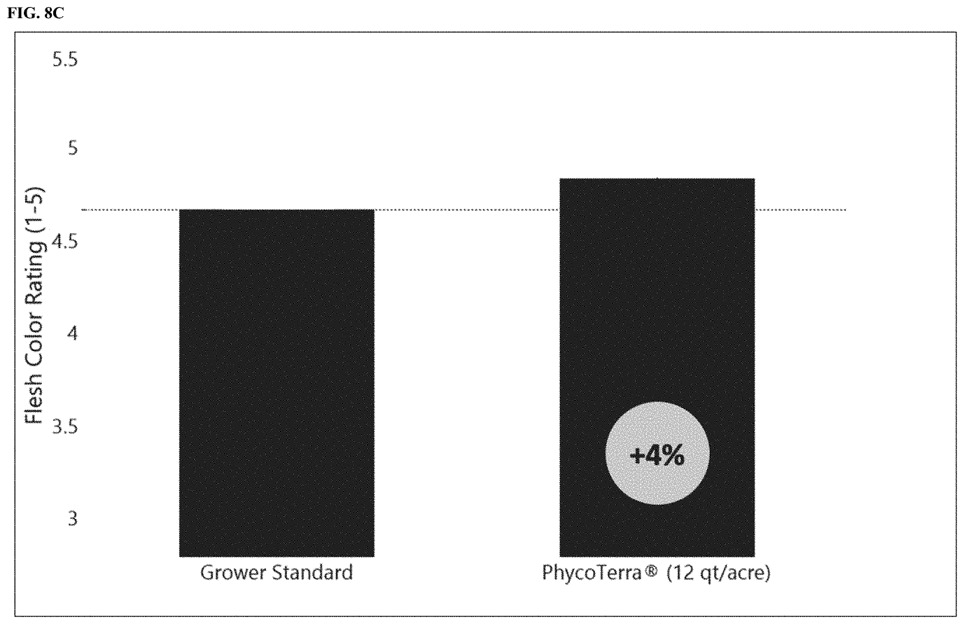

At harvest, the treated trees produced oranges with an average 4% increase in fruit size (FIG. 8A), an average decrease in rind thickness of 4% (FIG. 8B, thinner rinds are generally desirable), and an improvement in flesh color rating of an average of 4% (FIG. 8C) compared to the untreated control trees.

### Example 8. PHYCOTERRA® (Whole Cell Chlorella Microalgae) Improves the Fruit Grade and Fruit Color of Apples

A field trial was conducted with Fuji and Gala apple trees in Santa Catarina, Brazil where the trees grew in sandy clay loam soil having 3.8% organic matter. Four applications of PHYCOTERRA® (whole cell Chlorella microalgae) were made at 1 qt/acre. The first application started at blooming, and then three monthly applications were made with the last application occurring when fruits were 5 mm in diameter.

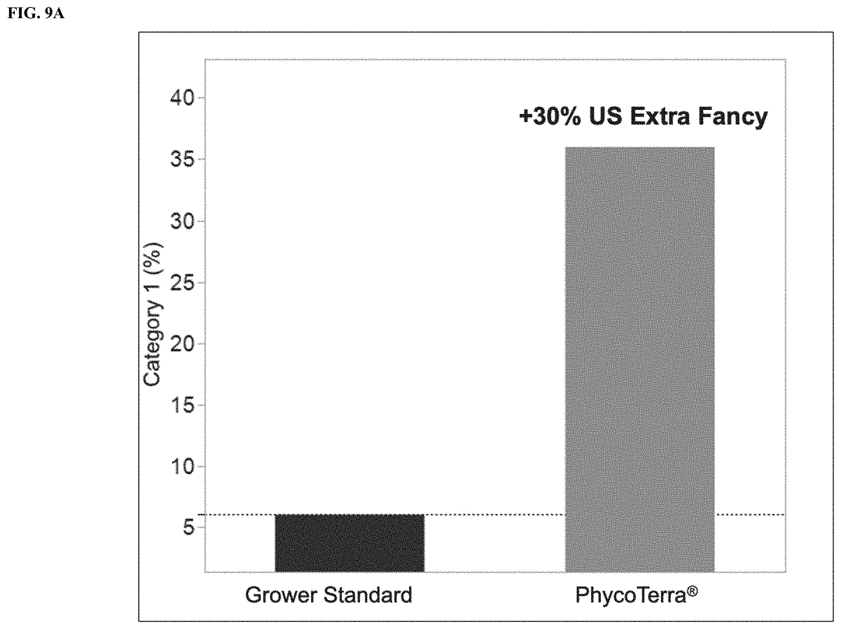

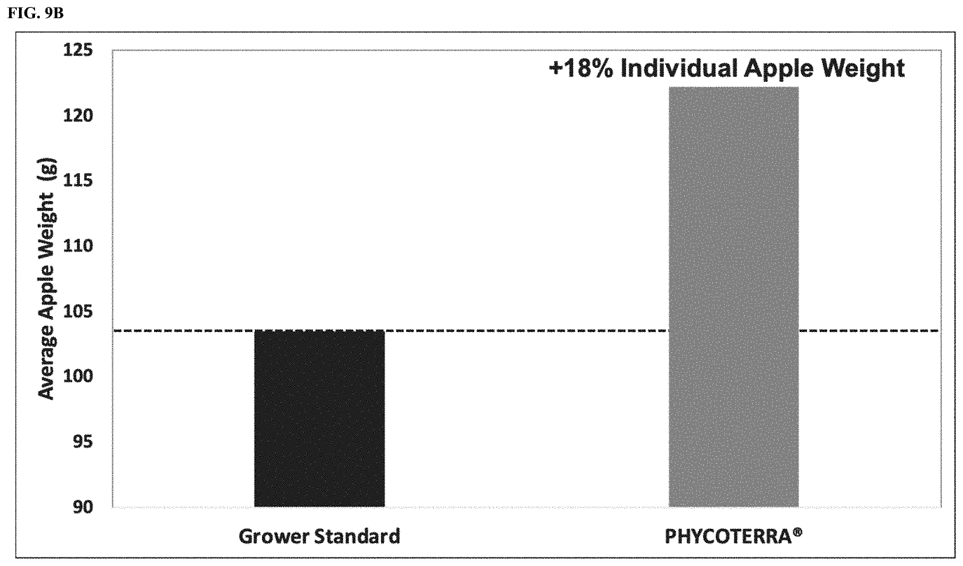

Application of PHYCOTERRA® (whole cell Chlorella microalgae) resulted in a 30% increase in the number of harvested apples graded as U.S Extra Fancy and an 18% increase in the average apple weight compared to untreated control apples (“Grower Standard”) (see FIGS. 9A and 9B). In addition for both Fuji and Gala apple trees, application of PHYCOTERRA® (whole cell Chlorella microalgae) produced an improvement in fruit color (see Table 7).

TABLE 7
Fruit color ratings of untreated apples (“Grower Standard”) and apples treated
with PHYCOTERRA ® (whole cell Chlorella microalgae).

| | Fruit | Fruit | Fruit | Fruit | Fruit |
|---|---|---|---|---|---|
| | Color | Color | Color | Color | Color |
| Treatment | (<10%) | (11-20%) | (21-40%) | (41-60%) | (>60%) |
| Grower | 20 | 44 | 30 | 6 | 0 |
| Standard | | | | | |
| PHYCOTERRA ® | 0 | 20 | 44 | 36 | 0 |

All headings are for the convenience of the reader and should not be used to limit the meaning of the text that follows the heading, unless so specified.

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present invention is not entitled to antedate such publication by virtue of prior invention.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

What is claimed is:

1. A method for improving crop yield and/or the quality of a harvested crop comprising the step of applying a composition comprising a culture of microalgae to a plant, a plant propagation material, and/or a locus where said plant or plant propagation material is intended to be grown.

2. The method of claim 1, wherein the composition comprises a culture of Aurantiochytrium, Botryococcus, Chlorella, Chlamydomonas, Desmodesmus, Dunaliella, Scenedesmus, Pavolv, Phaeodactylum, Nannochloropsis, Spirulina, Galdieria, Haematococcus, Isochrysis, Porphyridium, Schizochytrium, Thraustochytrium, Tetraselmis, or a combination thereof.

3. The method of claim 2, wherein the composition comprises a culture of Chlorella.

4. The method of claim 3, wherein the Chlorella are whole cells, lysed cells, dried cells, cells that have been subjected to an extraction process, or a combination thereof.

5. The method of claim 1, wherein the improvement in the quality of the harvested crop is an increase in individual crop weight, individual crop size, flesh color rating, crop or fruit grade, protein content, oil content, carbohydrate content, fiber content, grain hardness, number of hard and vitreous kernels of amber color (HVAC), relative feed value (RFV), total digestible nutrients (TDN), crude protein (CP), nutritional quality, forage quality, or forage digestibility compared to a corresponding crop to which the composition was not applied.

6. The method of claim 5, wherein the improvement in crop or fruit grade is an enhancement in one or more crop or fruit grade assessments selected from the group consisting of: sugar content or soluble solids, whole crop or fruit size, starch content, crop or fruit firmness or pressure, crop or fruit acidity, crop or fruit color, seed color, crop or fruit taste, crop or fruit texture, and crop or fruit aroma.

7. The method of claim 1, wherein the improvement in the quality of the harvested crop is a decrease in rind thickness, grain or kernel damage, grain or kernel chalkiness, or the number of nut doubles compared to a corresponding crop to which the composition was not applied.

8. The method of claim 1, wherein the composition is applied to soil in the immediate vicinity of the plant, seedling, or plant propagation material, as a seed treatment, and/or as a foliar spray.

9. The method of claim 8, wherein the composition is applied as a soil drench or foliar spray at a rate of between about 0.5 qt/acre (1.17 L/ha) and about 4 qt/acre (9.6 L/ha).

10. The method of claim 8, wherein the composition is applied as a seed treatment at a rate of about 1 oz/cwt (0.58 ml/kg) to about 6 oz/cwt (3.49 ml/kg).

11. The method of claim 1, wherein the harvested crop is an almond crop, wherein the composition is applied to an almond tree and/or a locus where an almond tree is intended to be grown,
wherein improvement in quality is measured as an increase in individual nut weight and/or a decrease in the number of doubles in the harvested almond crop compared to a corresponding almond crop to which the composition was not applied.

12. The method of claim 1, wherein the harvested crop is an alfalfa crop, wherein the composition is applied to an alfalfa plant, alfalfa propagation material, and/or a locus where an alfalfa plant is intended to be grown,
wherein improvement in quality is measured as an increase in relative feed value (RFV), total digestible nutrients (TDN), crude protein (CP), forage quality, or forage digestibility in the harvested alfalfa crop compared to a corresponding alfalfa crop to which the composition was not applied.

13. The method of claim 1, wherein the harvested crop is a wheat crop, wherein the composition is applied to a wheat plant, wheat propagation material, and/or a locus where a wheat plant is intended to be grown,
wherein improvement in quality is measured as an increase in protein content, grain hardness, or the number of hard and vitreous kernels of amber color (HVAC) in the harvested wheat crop compared to a corresponding wheat crop to which the composition was not applied.

14. The method of claim 1, wherein the harvested crop is a canola crop, wherein the composition is applied to a canola plant, canola propagation material, and/or a locus where a canola plant is intended to be grown,
wherein improvement in quality is measured as an increase in oil content in the harvested canola crop compared to a corresponding canola crop to which the composition was not applied.

15. The method of claim 1, wherein the harvested crop is a corn crop, wherein the composition is applied to a corn plant, corn propagation material, and/or a locus where a corn plant is intended to be grown,
wherein improvement in quality is measured as an increase in protein content in the harvested corn crop compared to a corresponding corn crop to which the composition was not applied.

16. The method of claim 1, wherein the harvested crop is a soybean crop, wherein the composition is applied to a soybean plant, soybean propagation material, and/or a locus where a soybean plant is intended to be grown,
wherein improvement in quality is measured as an increase in protein content in the harvested soybean crop compared to a corresponding soybean crop to which the composition was not applied.

17. The method of claim 1, wherein the harvested crop is a citrus fruit crop, wherein the composition is applied to a citrus fruit tree, citrus fruit propagation material, and/or a locus where a citrus fruit tree is intended to be grown,
wherein improvement in quality is measured as an increase in fruit size or flesh color rating and/or a decrease in rind thickness in the harvested citrus fruit crop compared to a corresponding citrus fruit crop to which the composition was not applied.

18. The method of claim 17, wherein the citrus fruit is an orange, lemon, lime, grapefruit, mandarin orange, tangerine, kumquat, pomelo, citron, papeda, or clementine.

19. The method of claim 1, wherein the harvested crop is an apple crop, wherein the composition is applied to an apple tree, apple propagation material, and/or a locus where an apple tree is intended to be grown,
wherein improvement in quality is measured as an improvement in fruit grade in the harvested apple crop compared to a corresponding apple crop to which the composition was not applied.

20. The method of claim 19, wherein the improvement in fruit grade is an enhancement in one or more fruit grade assessments selected from the group consisting of: sugar content or soluble solids, whole fruit size, starch content, fruit firmness or pressure, fruit acidity, fruit color, seed color, fruit taste, fruit texture, and fruit aroma.
